(19) United States
(12) Patent Application Publication
(10) Pub. No.: US 2022/0158232 A1
(43) Pub. Date: May 19, 2022

(54) ELECTROLYTE AND FABRICATING METHOD THEREOF, AND LITHIUM BATTERY

(71) Applicant: NATIONAL CHENG KUNG UNIVERSITY, Tainan City (TW)

(72) Inventors: Yu-hsing LIN, Tainan City (TW); Hsisheng TENG, Tainan City (TW); Yi-han SU, Tainan City (TW); Subramani RAMESH, Tainan City (TW); Thi Tuyet Hanh NGUYEN, Tainan City (TW); Yu-ting HUANG, Tainan City (TW)

(21) Appl. No.: 17/143,231

(22) Filed: Jan. 7, 2021

(30) Foreign Application Priority Data
Nov. 17, 2020 (TW) 109140185

(51) Int. Cl. H01M 10/0565; H01M 10/052

(52) U.S. Cl. CPC H01M 10/0565; H01M 2300/0082; H01M 2300/0085; H01M 10/052

(57) ABSTRACT

An electrolyte and a fabricating method thereof, and a lithium battery are described. The fabricating method of the electrolyte has steps of: adding a PVDF-based polymer and a PMA-based polymer to a liquid electrolyte to form a mixture, wherein the liquid electrolyte comprises a lithium salt; heating the mixture to between 60 and 100° C. for more than 4 hours, so as to form a transparent solution; and cooling the transparent solution to form the electrolyte. The electrolyte is a gel-state electrolyte between −60 and 80° C., which is suitable for use as an electrolyte in a lithium battery.

### CROSS REFERENCE TO RELATED APPLICATION

This application claims priority to Taiwan Patent Application No. 109140185, filed on Nov. 17, 2020, which is incorporated herein by reference in its entirety.

### FIELD OF DISCLOSURE

The present disclosure relates to batteries, and more particularly to an electrolyte and a fabricating method thereof, and a lithium battery.

### BACKGROUND OF DISCLOSURE

In recent years, lithium batteries have been widely used in a variety of electronic products, electric vehicles, or energy storage devices. Therefore, many studies focus on improving performance, energy density, and safety of the energy storage devices. In terms of safety, liquid electrolytes used in lithium batteries tend to have a risk of leakage so as to cause an explosion.

Therefore, it is necessary to provide an electrolyte and a fabricating method thereof, and a lithium battery to solve problems of the conventional technology.

### SUMMARY OF DISCLOSURE

An object of the present disclosure is to provide a fabricating method of an electrolyte, which is to add at least two kinds of polymers (such as polyvinylidene difluoride based (PVDF-based) polymer and poly(methyl acrylate) based (PMA-based) polymer to react with a lithium salt of a liquid electrolyte, so as to form the electrolyte that is gel-state at −60 to 80° C. Therefore, the fabricating method is simple.

Another object of the present disclosure is to provide an electrolyte, which is fabricated by the fabricating method of the electrolyte according to an embodiment of the present disclosure, wherein the electrolyte is a gel-state electrolyte between −60 and 80° C., which is suitable for use as an electrolyte in a lithium battery.

A further object of the present disclosure is to provide a lithium battery including the electrolyte of the present disclosure, which can avoid a risk of leakage of a liquid electrolyte between −60 and 80° C., and the lithium battery has excellent battery characteristics.

To achieve the above object, the disclosure provides a fabricating method of an electrolyte, comprising steps of: adding a PVDF-based polymer and a PMA-based polymer to a liquid electrolyte to form a mixture, wherein the liquid electrolyte comprises a lithium salt; heating the mixture at a temperature ranging from 60 to 100° C. for more than 4 hours, so as to form a transparent solution; and cooling the transparent solution to form the electrolyte.

In an embodiment of the present disclosure, the PVDF-based polymer is selected from a group consisting of polyvinylidene difluoride (PVDF), poly (vinylidene fluoride-trifluoroethylene) (P(VDF-TrFE)), poly(vinylidene fluoride-co-chlorotrifluoroethylene) PVDF-CTFE, poly(vinylidene fluoride-co-hexafluoropropylene) (PVDF-co-HFP), and derivatives thereof.

In an embodiment of the present disclosure, the PMA-based polymer is selected from a group consisting of poly(methyl acrylate) (PMA), polymethylmethacrylate (PMMA), poly(N-(2-Hydroxypropyl) methacrylamide (PHPMA), polyhydroxyethylmethacrylate (PHEMA), and derivatives thereof.

In an embodiment of the present disclosure, a weight ratio of the PVDF-based polymer to the PMA-based polymer is between 4:1 and 20:1.

In an embodiment of the present disclosure, a weight ratio of a total weight of the PVDF-based polymer and the PMA-based polymer to the liquid electrolyte is between 2:100 and 6:100.

In an embodiment of the present disclosure, the lithium salt comprises at least one of lithium bistrifluoromethylsulfonimide (LiTFSI), LiFSI, LiPF₆, LiClO₄, LiBOB, LiSO₄, and LiBF₄.

To achieve another object, the disclosure provides an electrolyte fabricated by a fabricating method of the electrolyte according to any one embodiment of the fabricating method of the electrolyte described above, wherein the electrolyte is a gel-state electrolyte between −60 and 80° C.

To achieve a further object, the disclosure provides a positive electrode material and a negative electrode material; and an electrolyte according to any one embodiment of the electrolyte described above, wherein the electrolyte is disposed between the positive electrode material and the negative electrode material.

In an embodiment of the present disclosure, the positive electrode material comprises at least one of LiCoO₂, ternary materials, and LiFePO₄.

In an embodiment of the present disclosure, the negative electrode material comprises at least one of graphite, lithium titanium oxide, and lithium metal.

### DESCRIPTION OF DRAWINGS

FIG. 1 is a schematic flow chart of a fabricating method of an electrolyte according to an embodiment of the present disclosure.

FIG. 2 is an exploded schematic view of a lithium battery according to an embodiment of the present disclosure.

FIG. 3A to FIG. 3E are respectively an analysis schematic diagram of a charge and discharge test of the lithium batteries of Embodiments 1 to 5 at room temperature (25° C.).

FIG. 4 is a schematic diagram of the capacity analysis of Embodiment 3 and commercial electrolyte after 500 cycles of long-term testing.

FIG. 5A is a schematic diagram of the analysis of a charge and discharge test performed in a folded state and an unfolded state of Embodiment 3 in a form of flexible packaging.

FIG. 5B is a schematic diagram of an analysis of a cyclic test in a folded state and an unfolded state of Embodiment 3 in a form of flexible packaging.

### DETAILED DESCRIPTION OF PREFERRED EMBODIMENTS

The structure and the technical means adopted by the present disclosure to achieve the above and other objects can be best understood by referring to the following detailed description of the preferred embodiments and the accompanying drawings. Furthermore, directional terms described by the present disclosure, such as upper, lower, front, back, left, right, inner, outer, side, longitudinal/vertical, transverse/horizontal, and etc., are only directions by referring to the accompanying drawings, and thus the used directional terms are used to describe and understand the present disclosure, but the present disclosure is not limited thereto.

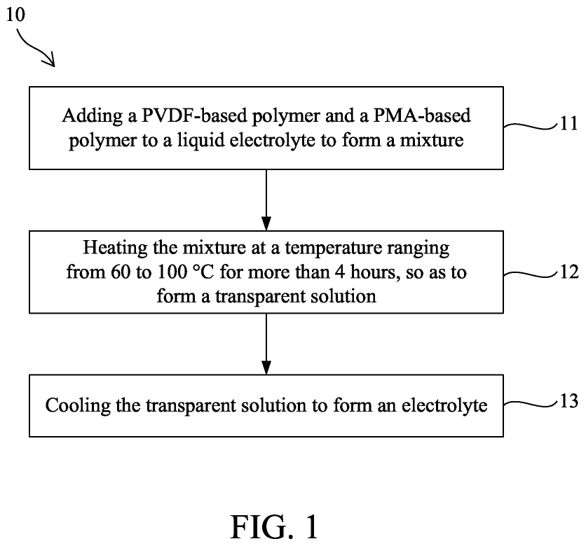

Referring to FIG. 1, an embodiment of the present disclosure provides a fabricating method 10 of an electrolyte mainly comprising steps 11 to 13 of: adding a PVDF-based polymer and a PMA-based polymer to a liquid electrolyte to form a mixture, wherein the liquid electrolyte comprises a lithium salt (step 11); heating the mixture at a temperature ranging from 60 to 100° C. for more than 4 hours, so as to form a transparent solution (step 12); and cooling the transparent solution to form the electrolyte (step 13). Details of the implementation and principles of the above-described steps of embodiments will be described in detail below.

In an embodiment of the present disclosure, the fabricating method 10 of the electrolyte has a step 11 of: adding a PVDF-based polymer and a PMA-based polymer to a liquid electrolyte to form a mixture, wherein the liquid electrolyte comprises a lithium salt. In step 11, specific polymers are mainly added into the liquid electrolyte containing lithium salt, so that the liquid electrolyte can be formed into a gel-state electrolyte at a specific temperature (for example, −60 to 80° C.) in subsequent steps. In an embodiment, the PVDF-based polymer is selected from a group consisting of polyvinylidene difluoride (PVDF), poly (vinylidene fluoride-trifluoroethylene) (P(VDF-TrFE)), poly(vinylidene fluoride-co-chlorotrifluoroethylene) PVDF-CTFE, poly(vinylidene fluoride-co-hexafluoropropylene) (PVDF-co-HFP), and derivatives thereof. In another embodiment, the PMA-based polymer is selected from a group consisting of poly(methyl acrylate) (PMA), polymethylmethacrylate (PMMA), poly(N-(2-Hydroxypropyl) methacrylamide (PHPMA), polyhydroxyethylmethacrylate (PHEMA), and derivatives thereof.

In a further embodiment, a weight ratio of the PVDF-based polymer to the PMA-based polymer is between 4:1 and 20:1. In an example, the weight ratio can be 5:1, 6:1, 8:1, 10:1, 12:1, 15:1, 17:1, 18:1, or 19:1. In another embodiment, a weight ratio of a total weight of the PVDF-based polymer and the PMA-based polymer to the liquid electrolyte (i.e., (the PVDF-based polymer and the PMA-based polymer): the liquid electrolyte) is between 2:100 and 6:100. In an example, the weight ratio is 3:100, 4:100, or 5:100. In an embodiment, the lithium salt comprises at least one of lithium bistrifluoromethylsulfonimide (LiTFSI), LiFSI, LiPF₆, LiClO₄, lithium bis(oxalate)borate (LiBOB), LiSO₄, and LiBF₄.

In an embodiment of the present disclosure, the fabricating method 10 of the electrolyte has a step 12 of: heating the mixture at a temperature ranging from 60 to 100° C. for more than 4 hours, so as to form a transparent solution. In step 12, the heating is mainly used to improve a uniform dissolution of the PVDF-based polymer and the PMA-based polymer in the liquid electrolyte, thereby improving the reaction (such as a crosslinking reaction). In an embodiment, the heating time of the reaction is, for example, 4 to 12 hours. In an example, the heating time is, for example, 5, 6, 7, 8, 9, 10, or 11 hours.

In an embodiment of the present disclosure, the fabricating method 10 of the electrolyte has a step 13 of: cooling the transparent solution to form the electrolyte. In step 13, for example, the transparent solution can form the electrolyte by standing and air cooling.

It should be noted that at least one feature of fabricating method of the electrolyte in an embodiment of the present disclosure is that: at least the PVDF-based polymer and the PMA-based polymer need to be added to cross-link with the lithium salt, so as to fabricate an electrolyte that is gel-state at −60 to 80° C. Therefore, the leakage problem caused by the liquid electrolyte is avoided. Further, if only the PVDF-based polymer is added for cross-linking reaction with the lithium salt, the electrolyte does not have a characteristic of being gel-state in a specific temperature range (for example, −60 to 80° C.). Similarly, if only the PMA-based polymer is added for cross-linking reaction with the lithium salt, the electrolyte does not have a characteristic of being gel-state in a specific temperature range (for example, −60 to 80° C.).

An embodiment of the present disclosure provides an electrolyte fabricated by a fabricating method of the electrolyte according to any one of embodiments of the present disclosure, wherein the electrolyte is a gel-state electrolyte between −60 and 80° C.

It should be mentioned that the electrolyte of an embodiment of the present disclosure is fabricated through a specific method, so that the electrolyte is in a gel-state between −60 and 80° C. Since the use of general lithium batteries does not exceed the above-mentioned temperature range, the electrolyte can be used in lithium batteries. It is worth mentioning that, the electrolyte of the present disclosure transforms into a liquid state at a temperature lower than −60° C. or higher than 80° C., which is based on the characteristics of a molecular structure formed by the reaction of polyvinylidene fluoride polymer and polymethyl acrylate polymer.

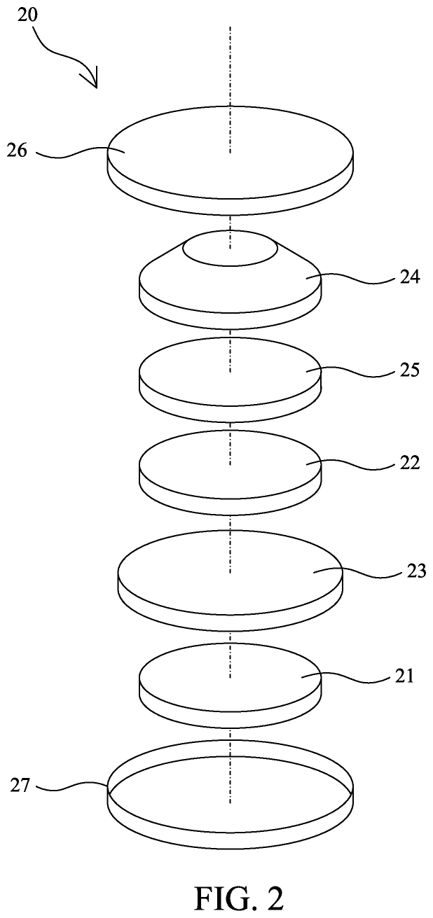

Referring to FIG. 2, an embodiment of the disclosure provides a lithium battery 20 comprising: a positive electrode material 21 and a negative electrode material 22; and an electrolyte 23. The electrolyte 23 is disposed between the positive electrode material 21 and the negative electrode material 22, wherein the electrolyte 23 is an electrolyte according to any one of embodiments of the present disclosure. In an embodiment, the positive electrode material 21 comprises at least one of LiCoO₂, ternary materials, and LiFePO₄. In an embodiment, the negative electrode material 22 comprises at least one of graphite, lithium titanium oxide, and lithium metal. In still another embodiment, the electrolyte 23 can be fabricated by a fabricating method of a gel-state electrolyte according to any one of embodiments of the present disclosure.

In an embodiment, a specific structure of the lithium battery 20 can further include a reed 24 and a gasket 25. For example, each component in the lithium battery 20 is sequentially assembled into an upper casing 26, the reed 24, the gasket 25, the negative electrode material 22, the gel-state electrolyte 23, the positive electrode material 21, and a lower case 27.

The following embodiments are presented to illustrate that the fabricating method of the electrolyte according to embodiments of the present disclosure can indeed fabricate an electrolyte which is gel-state at a temperature between −60 and 80° C. Further, the lithium battery with the electrolyte has excellent battery characteristics.

### Embodiment 1

A PVDF-based polymer (such as PVDF-co-HFP) and a PMA-based polymer (such as PHEMA) are added into a liquid electrolyte to form a mixture. The liquid electrolyte has 1 M of a lithium salt (such as at least one of lithium bistrifluoromethylsulfonimide (LiTFSI), LiFSI, LiPF₆, LiClO₄, LiBOB, LiSO₄, and LiBF₄) in ethylene carbonate (EC), dimethyl carbonate (DMC), and diethyl carbonate (DEC) in a volume ratio of 1:1:1. A weight ratio of the PVDF-based polymer to the PMA-based polymer is about 4:1. A weight ratio of a total weight of the PVDF-based polymer and the PMA-based polymer (hereinafter referred to as two kinds of polymers) to the liquid electrolyte is about 2.5:100. Then, the mixture is heated between 60 and 100° C. for more than 4 hours to form a transparent solution. Then, it is allowed to stand at room temperature to cool the transparent solution to form the electrolyte of Embodiment 1.

It is worth mentioning that the electrolyte just prepared (Embodiment 1) is a flowable liquid (Sol Type). When the temperature is at room temperature for a period of time, the electrolyte gradually changes from a flowable-state to a gel-state (Gel Type). After that, it will maintain a gel-state at a temperature ranging from −60° C. to 80° C. Therefore, in the temperature range (for example, −40 to 60° C.) where the battery is generally used, even if the battery is damaged by an external force, there is no danger of electrolyte leakage, which has a safety.

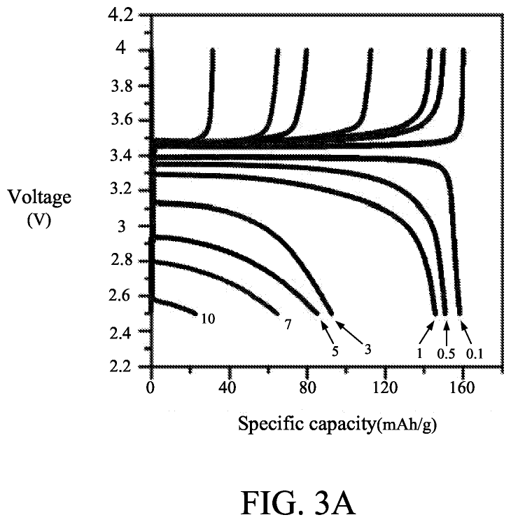

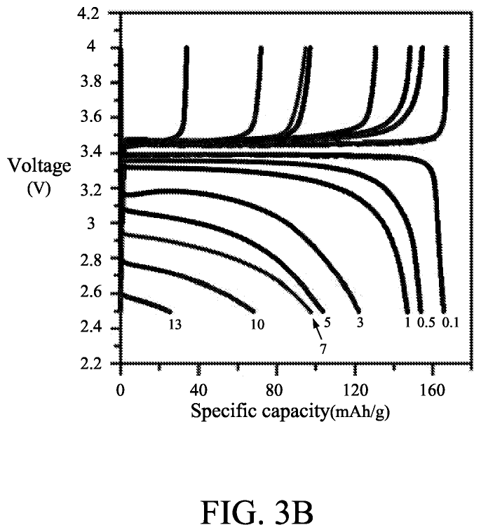

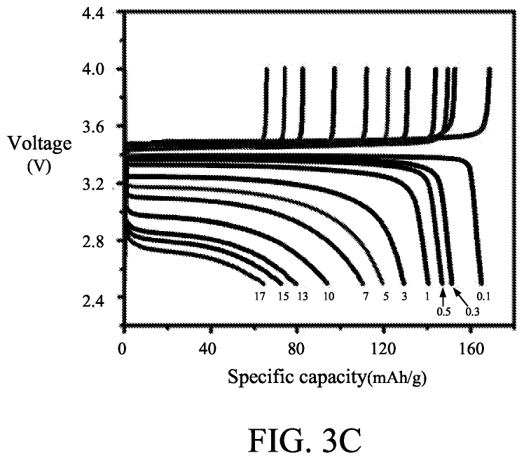

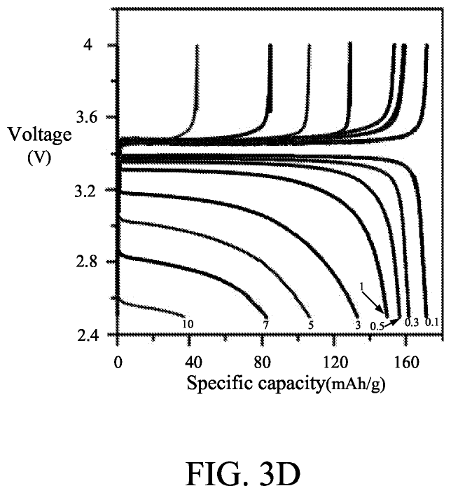

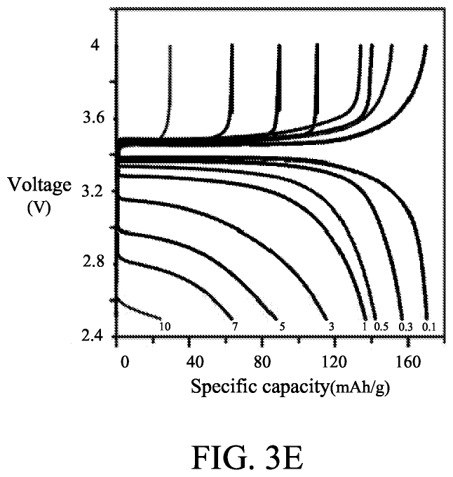

Next, the electrolyte of Embodiment 1 is combined with the lithium iron phosphate positive electrode and the lithium metal negative electrode to form a lithium battery. A charge and discharge test is performed to the lithium battery at room temperature (about 25° C.). Results of Embodiment 1 are shown in FIG. 3A.

### Embodiments 2 to 5

The fabricating methods of Embodiments 2 to 5 are roughly the same as Embodiment 1. The difference is that: a weight ratio of the PVDF-based polymer and the PMA-based polymer is different (Embodiments 2 and 3), and a weight ratio of a total weight of the PVDF-based polymer and the PMA-based polymer to the liquid electrolyte is different (Embodiments 4 and 5). Please refer to Table 1 below.

TABLE 1

| | a weight ratio of the | a weight ratio of |
|---|---|---|
| | PVDF-based polymer | two kinds of |
| | and the PMA-based | polymers and |
| | polymer | the liquid electrolyte |
| Embodiment 1 | 4:1 | 2.5:100 |
| Embodiment 2 | 9:1 | 2.5:100 |
| Embodiment 3 | 19:1 | 2.5:100 |
| Embodiment 4 | 19:1 | 5:100 |
| Embodiment 5 | 19:1 | 6:100 |

It is worth mentioning that the electrolyte just prepared (Embodiments 2 to 5) is a flowable liquid (Sol Type). When the temperature is at room temperature for a period of time, the electrolyte gradually changes from a flowable-state to a gel-state (Gel Type). After that, it will maintain a gel-state at a temperature ranging from −60° C. to 80° C. Therefore, when the battery is damaged by an external force, there is no danger of electrolyte leakage, which has a safety.

Next, each of the electrolytes of Embodiments 2 to 5 is combined with the lithium iron phosphate positive electrode and the lithium metal negative electrode to form a lithium battery. A charge and discharge test is performed to the lithium battery at room temperature (about 25° C.). Results of Embodiments 2 to 5 are shown in FIG. 3B to FIG. 3E, respectively.

It can be known from FIG. 3A to FIG. 3E that:

The capacity of Embodiment 1 at a discharge rate of 0.1 C-rate at room temperature is about 158.2 mAh/g, and at a discharge rate of 10 C-rate at room temperature, the electric capacity is about 22.7 mAh/g.

The capacity of Embodiment 2 at a discharge rate of 0.1 C-rate at room temperature is about 165.7 mAh/g, and at a discharge rate of 13 C-rate at room temperature, the electric capacity is about 25.4 mAh/g.

The capacity of Embodiment 3 at a discharge rate of 0.1 C-rate at room temperature is about 164.9 mAh/g, and at a discharge rate of 15 C-rate at room temperature, the electric capacity is about 72 mAh/g.

The capacity of Embodiment 4 at a discharge rate of 0.1 C-rate at room temperature is about 169.2 mAh/g, and at a discharge rate of 10 C-rate at room temperature, the electric capacity is about 37.2 mAh/g.

The capacity of Embodiment 5 at a discharge rate of 0.1 C-rate at room temperature is about 169.5 mAh/g, and at a discharge rate of 10 C-rate at room temperature, the electric capacity is about 23.9 mAh/g.

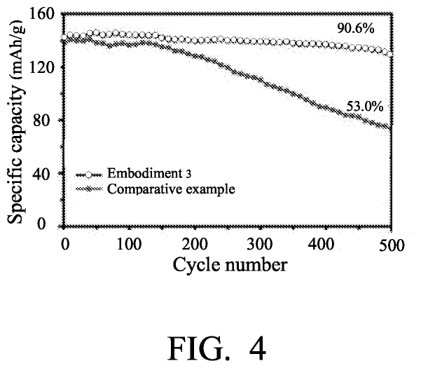

Next, the embodiment is compared with a commercial lithium battery (the electrolyte of which is a commercial electrolyte (1M LiPF₆ in EC/DMC/DEC=1:1:1), hereinafter referred to as a comparative example). Here, mainly the comparison between Example 3 and the comparative example are shown. After a long-term test of 500 cycles with 1 C-rate charging and 1 C-rate discharging, results of battery discharge capacity are observed. Please refer to FIG. 4, after 500 cycles of testing, a capacity retention rate of Embodiment 3 (90.6%) is better than that of the comparative example (53.0%). It is worth mentioning that Embodiments 1, 2, 4, and 5 also have similar capacity retention rates to Embodiment 3.

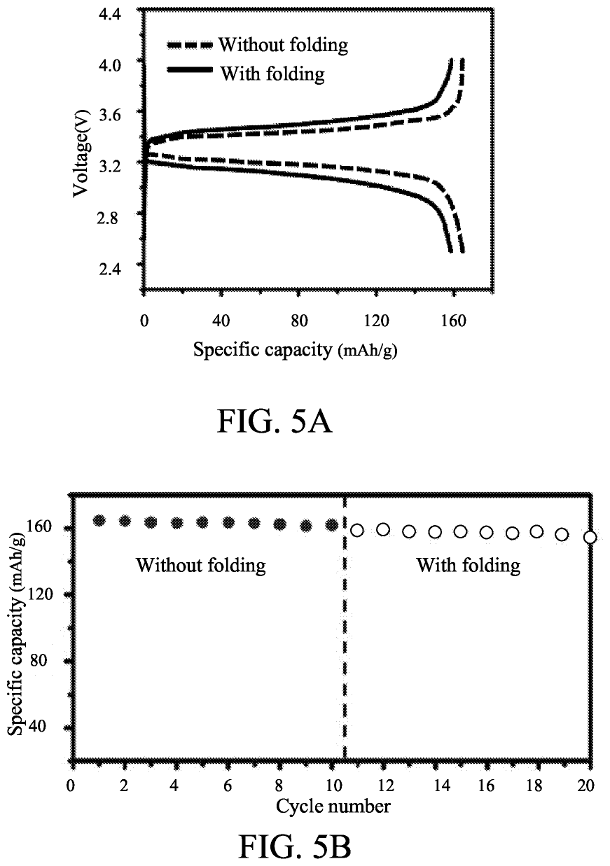

Taking Embodiment 3 as an example, the lithium battery of Embodiment 3 is packaged in a flexible package. Then, the flexible package is measured for capacity in a folded state and an unfolded state. As shown in FIG. 5A, there is no significant difference in the capacity of the lithium battery in the folded state and the lithium battery in the unfolded state. In addition, cycle performance tests of the folded lithium battery and the unfolded lithium battery do not have a significant difference, as shown in FIG. 5B (the first 10 cycles are the lithium battery in the unfolded state, and the following 10 cycles are the lithium battery in the folded state (for example, folded in half), which is found that the cycle performance is not greatly affected). Therefore, it means that if the lithium battery is damaged by external force, it can still maintain its certain performance. Similarly, Embodiments 1, 2, 4, and 5 also have similar effects to Embodiment 3 described above.

It can be seen from the above that Embodiments 1 to 5 are indeed still gel-state at a temperature range of −60° C. to 80° C. Therefore, in a common application temperature of a general lithium battery, the electrolyte of present disclosure exhibits a gel-state. In other words, when the battery is damaged by external force, there is no danger of electrolyte leakage, which has safety. In addition, Embodiments 1 to 5 also have better capacitance retention rates than commercial electrolytes. Furthermore, the lithium batteries of Embodiments 1 to 5 can also be arranged in a folded manner without significantly affecting their performance, which is convenient for installation in various devices that need to install batteries.

The present disclosure has been described with a preferred embodiment thereof and it is understood that many changes and modifications to the described embodiment can be carried out without departing from the scope and the spirit of the disclosure that is intended to be limited only by the appended claims.

1. A fabricating method of an electrolyte, comprising steps of:
adding a PVDF-based polymer and a PMA-based polymer to a liquid electrolyte to form a mixture, wherein the liquid electrolyte comprises a lithium salt;
heating the mixture at a temperature ranging from 60 to 100° C. for more than 4 hours, so as to form a transparent solution; and
cooling the transparent solution to form the electrolyte.

2. The fabricating method of the electrolyte according to claim 1, wherein the PVDF-based polymer is selected from a group consisting of polyvinylidene difluoride (PVDF), poly (vinylidene fluoride-trifluoroethylene) (P(VDF-TrFE)), poly(vinylidene fluoride-co-chlorotrifluoroethylene) PVDF-CTFE, poly(vinylidene fluoride-co-hexafluoropropylene) (PVDF-co-HFP), and derivatives thereof.

3. The fabricating method of the electrolyte according to claim 1, wherein the PMA-based polymer is selected from a group consisting of poly(methyl acrylate) (PMA), polymethylmethacrylate (PMMA), poly(N-(2-Hydroxypropyl) methacrylamide (PH PMA), polyhydroxyethylmethacrylate (PHEMA), and derivatives thereof.

4. The fabricating method of the electrolyte according to claim 1, wherein a weight ratio of the PVDF-based polymer to the PMA-based polymer is between 4:1 and 20:1.

5. The fabricating method of the electrolyte according to claim 1, wherein a weight ratio of a total weight of the PVDF-based polymer and the PMA-based polymer to the liquid electrolyte is between 2:100 and 6:100.

6. The fabricating method of the electrolyte according to claim 1, wherein the lithium salt comprises at least one of lithium bistrifluoromethylsulfonimide (LiTFSI), LiFSI, LiPF₆, LiClO₄, LiBOB, LiSO₄, and LiBF₄.

7. An electrolyte fabricated by a fabricating method of the electrolyte according to claim 1, wherein the electrolyte is a gel-state electrolyte between −60 and 80° C.

8. The electrolyte according to claim 7, wherein the PVDF-based polymer is selected from a group consisting of polyvinylidene difluoride (PVDF), poly (vinylidene fluoride-trifluoroethylene) (P(VDF-TrFE)), poly(vinylidene fluoride-co-chlorotrifluoroethylene) PVDF-CTFE, poly(vinylidene fluoride-co-hexafluoropropylene) (PVDF-co-HFP), and derivatives thereof.

9. The electrolyte according to claim 7, wherein the PMA-based polymer is selected from a group consisting of poly(methyl acrylate) (PMA), polymethylmethacrylate (PMMA), poly(N-(2-Hydroxypropyl) methacrylamide (PHPMA), polyhydroxyethylmethacrylate (PHEMA), and derivatives thereof.

10. The electrolyte according to claim 7, wherein a weight ratio of the PVDF-based polymer to the PMA-based polymer is between 4:1 and 20:1.

11. The electrolyte according to claim 7, wherein a weight ratio of a total weight of the PVDF-based polymer and the PMA-based polymer to the liquid electrolyte is between 2:100 and 6:100.

12. The electrolyte according to claim 7, wherein the lithium salt comprises at least one of lithium bistrifluoromethylsulfonimide (LiTFSI), LiFSI, LiPF₆, LiClO₄, LiBOB, LiSO₄, and LiBF₄.

13. A lithium battery, comprising:
a positive electrode material and a negative electrode material; and
an electrolyte according to claim 7, wherein the electrolyte is disposed between the positive electrode material and the negative electrode material.

14. The lithium battery according to claim 13, wherein the positive electrode material comprises at least one of LiCoO₂, ternary materials, and LiFePO₄.

15. The lithium battery according to claim 13, wherein the negative electrode material comprises at least one of graphite, lithium titanium oxide, and lithium metal.

16. The lithium battery according to claim 13, wherein the PVDF-based polymer is selected from a group consisting of polyvinylidene difluoride (PVDF), poly (vinylidene fluoride-trifluoroethylene) (P(VDF-TrFE)), poly(vinylidene fluoride-co-chlorotrifluoroethylene) PVDF-CTFE, poly(vinylidene fluoride-co-hexafluoropropylene) (PVDF-co-HFP), and derivatives thereof.

17. The lithium battery according to claim 13, wherein the PMA-based polymer is selected from a group consisting of poly(methyl acrylate) (PMA), polymethylmethacrylate (PMMA), poly(N-(2-Hydroxypropyl) methacrylamide (PHPMA), polyhydroxyethylmethacrylate (PHEMA), and derivatives thereof.

18. The lithium battery according to claim 13, wherein a weight ratio of the PVDF-based polymer to the PMA-based polymer is between 4:1 and 20:1.

19. The lithium battery according to claim 13, wherein a weight ratio of a total weight of the PVDF-based polymer and the PMA-based polymer to the liquid electrolyte is between 2:100 and 6:100.

20. The lithium battery according to claim 13, wherein the lithium salt comprises at least one of lithium bistrifluoromethylsulfonimide (LiTFSI), LiFSI, LiPF₆, LiClO₄, LiBOB, LiSO₄, and LiBF₄.
